(19) United States
(12) Patent Application Publication
(10) Pub. No.: US 2008/0155400 A1
(43) Pub. Date: Jun. 26, 2008

(54) Terminal Independent Addressing System for Access to a Web Page Via a Public Mobile Network

(76) Inventor: Maria Christensen, Boden (SE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/817,098

(22) PCT Filed: Feb. 23, 2006
(86) PCT No.: PCT/SE06/00238

§ 371 Date: Sep. 7, 2007

(30) Foreign Application Priority Data
Feb. 25, 2005 (SE) SE 0500429-6

(51) Int. Cl. G06F 15/16; G06F 3/14

(52) U.S. Cl. 715/273; 709/218

(57) ABSTRACT

A terminal independent addressing system (1) for access via a public mobile network to a web page. The system—(1) operates the access (7) from a number of different types of mobile terminals (3). In the mobile terminals (3) an URL is utilized which is always the same, regardless if the mobile terminal (3) is a WAP telephone or supports XHTML or similar. An example of an URL is www.contentprovider.com. The utilized URL is the same as the one utilized for previously existing PC-adapted web page. Owing to the system (1) a user can utilize only one address (5), which is unlike previously known technique, where among others, WAP pages have different addresses such as wap.contentprovider.com.

### TECHNICAL FIELD

The invention concerns a system to enable access to web pages from terminals which communicate via a public mobile network.

### BACKGROUND ART

There are relatively a great number of known techniques to facilitate accessing to data and information via a public mobile telephone system and the Internet.

A problem is reducing the number of available web addresses a user needs to have for accessing a number of web pages or objects. When using previously-known technique these addresses often depend on the type of the mobile terminal the user utilizes. An example of a mobile terminal is a mobile telephone, a palm computer or a PDA (Personal Digital Assistant). A public mobile telephone system can be based on 2-G, 2.5-G or 3-G or similar. A specific problem appears in some cases when the user utilizes a Personal Computer (PC) with a web browser connected and in other case utilizes a mobile terminal, e.g. a mobile telephone, for information access from a content provider. Example of a content provider is a news site, a hotel reservation site or a game site. When using previously-known technique the user must in general have access to two addresses, one address for a PC adapted web page and the other one, e.g. a WAP based web page. A web page in this document refers to a page containing certain information. Example on such information is opening hours for a restaurant, details of a hotel reservation or a visiting address including driving directions. Further, a web page in this document refers to that the content can be retrieved in different versions adapted to mobile terminal type. Background to this is that a mobile telephone and other mobile terminals support other protocols than those supported by a PC. For this reason, certain content providers convert selected parts of the information PC web page adapted to specific web pages for the mobile terminals. An example of such a page is a WAP side (Wireless Application Protocol). A WAP page has an address that differs from the web page adapted to PC. An example of a PC adapted web page address is www.contentprovider.com. An example of an address corresponding WAP side is www.contentprovider.com/wap. A further example of a common designation for a WAP page is wap.contentprovider.com.

An intention with WAP specification was to create an open standard which enables access to services from mobile terminals where the services come from different providers. There are e.g. WAP based services for searching of telephone numbers or for accessing the latest news. WAP specifications define a set-up format that is utilized for establishing wireless services. In principle, WAP enables the content in an existing PC web page convert to a WAP based format.

There are a number of mobile terminals that has a capability to support html, which in theory means that data requests from such terminals may use the same address as in a data request generated by a PC. In practice that approach is rarely used of the simple reason that in general a web page for a PC is not suitable to present on a mobile terminal. Two typical drawbacks are related to the size of the page, the amount of information available on the page and to the available bandwidth to connect the mobile terminal. Another problem is that capabilities to support colors vary between different types of terminals. It proved to be difficult to guarantee a user-friendly environment in terminals when the different terminals implement presentation and interaction in different ways. For example, there is a variation of the sizes of screens/displays, methods for user interaction and capacity in the terminal processors.

Most mobile terminals include information in data requests that states that the terminal does support a certain standard, such as stating that the mobile terminal supports XHTML. A problem is for a service provider to handle data requests from mobile terminals that the manufacturer states supports a certain standard, yet in practice does not.

WO2004/002118 describes a system and method for using numeric addresses to access a resource on the world wide web. The method includes selecting a character string corresponding to the resource; mapping the character string to a numeric string. Providing access to the resource by accepting the character string and the top level domain extension to be entered on a web enabled device, wherein the resource is located by utilizing the numeric string domain address. One example is a string with .wap as domain extension. A remaining problem with the system and method is that several strings addresses are necessary to support several types of mobile terminals.

WO2004/068885 describes that at least one user equipment is configured to spontaneously integrate an identifier that indicates its user equipment version within a defined signaling message transmitted from the user equipment to a network element, and at least one network element is configured to receive the signaling message and to extract the identifier that indicates the user equipment version from the signaling message. Several problems are not solved by WO2004/068885. For instance it is not disclosed how to enable that one generic www address is used in data requests from a variety of mobile terminals.

US 2003,006,994,2 describes a process to localize URI or URL to expand the pool of descriptive domain names that can be registered, and to make the Internet an enhancing localized media.

In practice a user cannot utilize one and the same addressing to a web page regardless of the terminal type. The address depends on the terminal. An example of such situation is when a company wants to send a bookmark as an SMS to a user with a company's mobile page address. But what address should be sent? Should it be a bookmark for WAP-addressing, a bookmark for xhtml compatible telephones or a bookmark for PDA:s? Or should it be a bookmark for access from a PC?

A remaining problem for known systems is that they need to evaluate which address to send as a bookmark. Some possible alternatives are an address to an index page supporting xhtml or wap. Other criterias that may be necessary to evaluate is the screen width of the terminal.

Another alternative is that the requesting terminal is a PC, and the bookmark in that case should be an address to an index file supporting html.

### SUMMARY OF THE INVENTION

In view of the above mentioned problems an object of the invention is to present a system comprising means to enhance presentation of web based data to a large number of different mobile terminals having different presentation capabilities. Another object is to present a system comprising means to handle a data request from a mobile terminal or from a PC, each of the data requests comprising exactly the same text based address to a web page, such as www.contentprovider.com, independent of if a user initiates a data request from a PC with a web browser or from a mobile terminal, such as a mobile phone with a WAP reader or from a PDA with a reader supporting xhtml or similar types of mobile terminals.

The system comprises terminal dependent pages, and further the system comprises a first means which manages a data request from a mobile terminal sent via a public mobile telephone system to a web page where the data request comprises exactly the same address utilized during a traditional access to the web page from a web browser in a PC. The system comprises a switching means to switch the access to the terminal dependent version of the web page compatible with the mobile terminal. Further characteristic are specified in the claims.

In an environment where a web version for a mobile terminal is added, the index file for the PC may be kept in its original form and a switching procedure forwards the data request from the mobile terminal to an index file adjusted to the mobile terminal. As the original index file for the PC version is kept, the weights relating to the web version for a PC is kept in search engines.

A further advantage with the invention is that it enables extension of the mobile functionality offered by a content provider to support a wide range of mobile terminals. Such an extension enables that a sub-set of services and information adapted to support a web browser in a PC, and available prior to the extension is made available for access from the mobile terminals. A user utilizes the previously known address, e.g. www.contentprovider.com, to initiate a data request from his/her mobile terminal.

In one aspect of the invention the system enables access from the mobile terminal to a determined subset of the information previously available only as a PC web page version. The subset of the information may be automatically retrieved from a database at a data request from the mobile terminal.

A further advantage with the invention is that switching can be executed towards a plurality of types of mobile terminals.

In one aspect of the invention the mobile terminal communicates via GPRS and presents information using WAP. The invention is also appropriate in case the mobile terminal presents information using other types of presentational standards such as html or xhtml. In another aspect of the invention the mobile terminal communicates via 3G.

These and other features, advantages and objects of the present invention will be further understood and appreciated by those skilled in the art by reference to the following specification, claims and appended drawings.

### FIGURE DESCRIPTION

The invention is described in under reference to attached figures, where

FIG. 1a shows an overview of a system according to the invention. The system comprises a switching means configured such that switching to the terminal dependent page compatible with the mobile terminal is performed.

FIG. 1b shows that exactly the same address utilized in access from the mobile terminal is utilized in the access to the PC web page version, too.

FIG. 2a is an overview of an embodiment where the system is applied to support a web hosting environment. The data request is forwarded by a first module which receives the data request, to a second module. The second module operates such that it performs switching to the terminal dependent page.

FIG. 2b is a system according to the invention applied in a web hosting environment where terminal dependant pages are automatically generated.

### DETAILED DESCRIPTION OF THE INVENTION

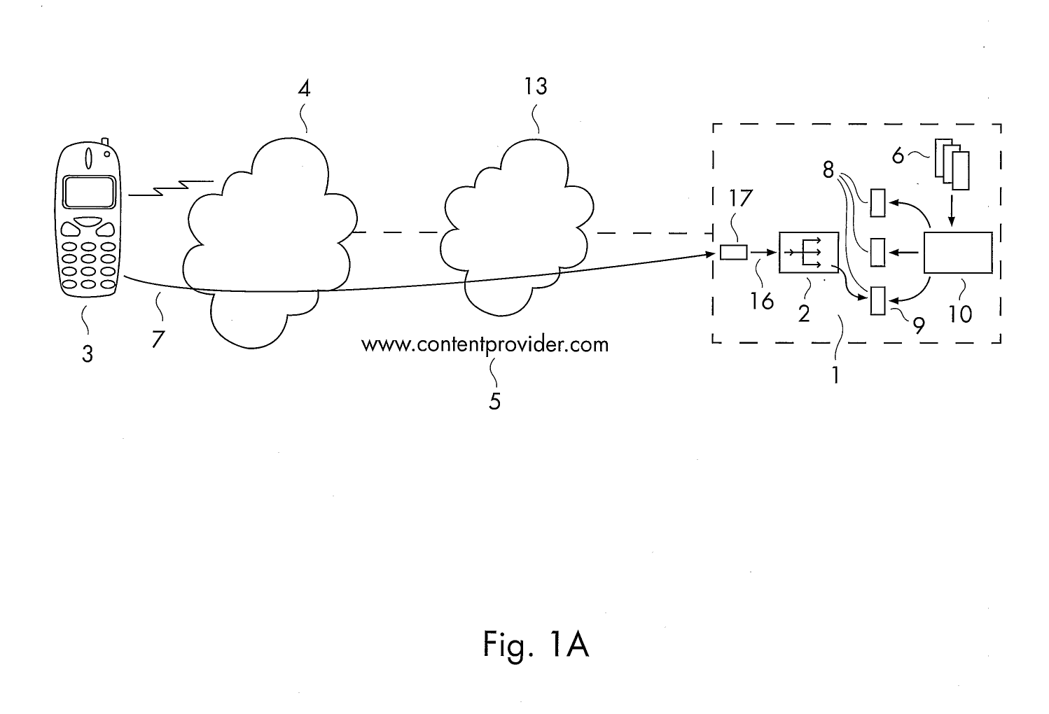

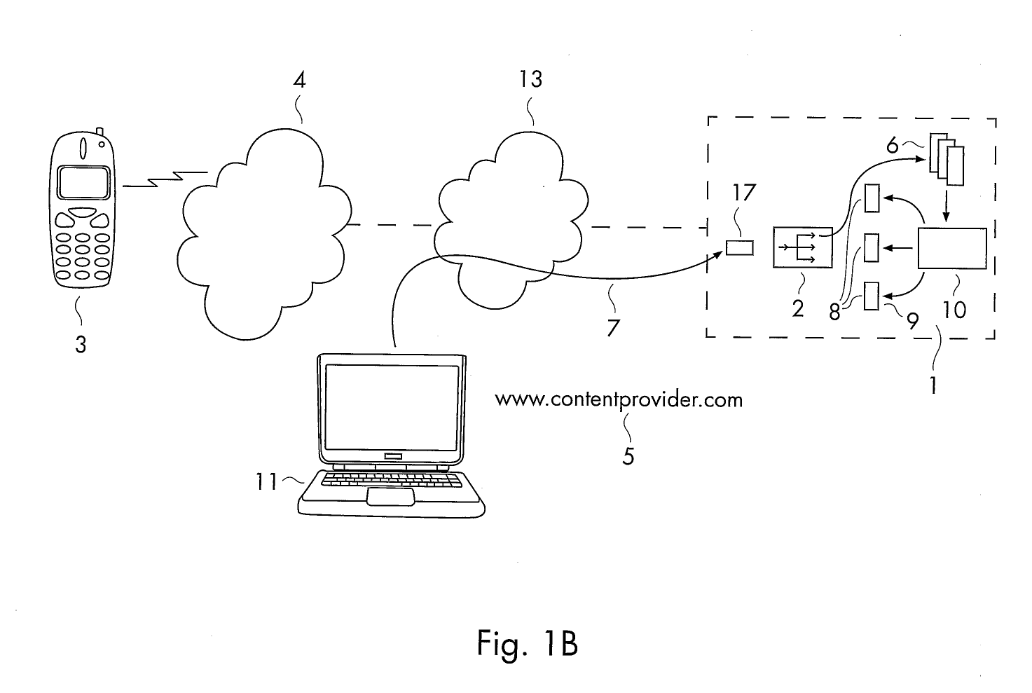

FIG. 1a shows an overview of the system 1 according to the invention. The system is configured such that in the mobile terminals a URL is utilized which is always the same to access a certain web page, regardless if the mobile terminal is a WAP telephone or supports XHTML or similar. An example of the address, which is a text based URL, is www.contentprovider.com. The utilized URL is the same as the one utilized for a previously existing PC-adapted web page. In a preferred embodiment a first software means 17 forwards 16 the incoming data request 7 to a switching means 2. Switching is performed by the switching means 2. The switching means 2 in FIG. 1a comprises software means interpreting which type of a mobile terminal 3 performing the data request 7 as well as capabilities of the terminal 3. The switching means interprets which of the terminal dependant pages 8 that is the version 9 of the web page compatible with the mobile terminal 3. The switching means 2 may also interpret other types of units such as a PC and a TV-set. The address 5, such as www.serviceprovider.com, is exactly the same address 5 which is utilized during a traditional access from a PC 11. In an embodiment the plurality of terminal dependent pages 8 are created by the auto generating means 10. Auto generating is typically preceded by choosing data, text, graphics, JAVA based functions or similar in the PC version of the web page. When the information in the PC version is being updated, such as opening hours, an updated terminal dependent version 9 of the web page may be auto generated. With the invention at hand a service provider, such as company or a public institution, is able to offer its clients mobile entries without having to change the code, functionality or software in the existing web page for PC. The invention enables to utilize investments already made targeting PC users, and at the same time offering an added mobile functionality. The result of the data request 7 can be that data sent between the public network provider 4 and the system 1 is made via internet 13. The mobile terminal 3 is able to support xhtml, wap or html or similar. In case the mobile terminal 3 comprises presentation means which supports xhtml, html or similar the switching means 2 reads capabilities from the terminal such as screen width. A xhtml dialect of frequent occurrence for mobile telephones is MP (Mobile Profile). An example of mobile terminals which interpret html with a common interrupt handling is PDA:s (Personal Data Administrator). The switching means 2 is implemented advantageously on commonly known server platforms which support Windows XP, UNIX, LINUX and similar. The switching means 2 may reside in a hosted environment or in a server operated by the content provider. In a hosted environment owners of information, such as a content provider, may forward the responsibility for maintenance and operation of the system 1 to the host.

FIG. 1b shows an overview of a data request 7 from a PC 11 to the PC version 6 of the web page. FIG. 1b also shows that exactly the same address 5 which is used in the data request 7 from the mobile terminal 3 is utilized in the access 5 to the PC version 6 of the web page. Access to the PC version 6 of the web page is typically made via a broadband network and the Internet 13. The PC version 6 of the web page typically contains considerably more information than the terminal dependent version of the web page 9. The data request 7 in FIG. 1b may generate that an SMS or an E-mail is sent from the service provider to the mobile terminal 3, such an SMS or E-mail comprising a distribution of a game or a tune.

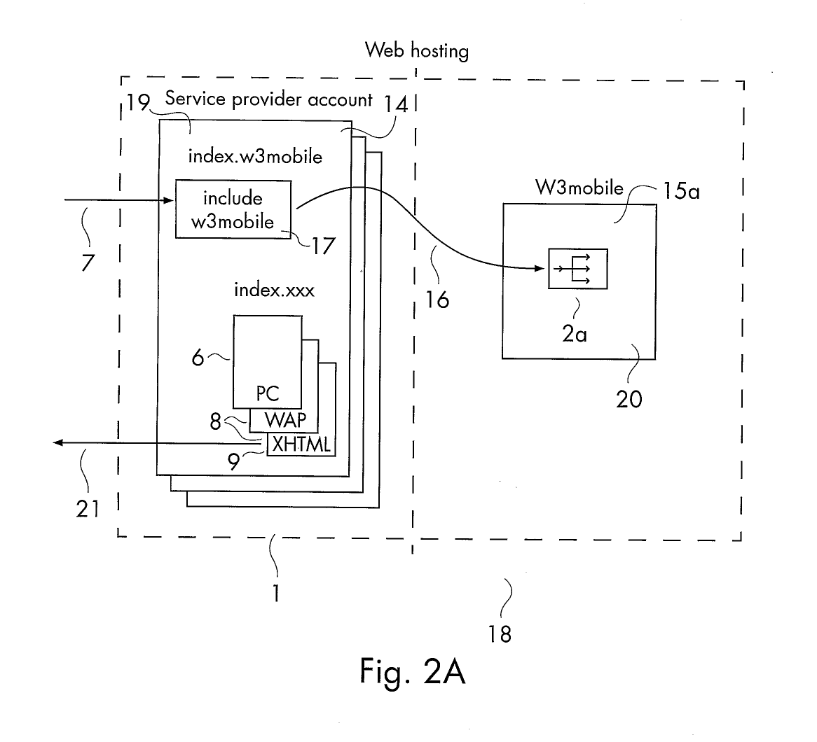

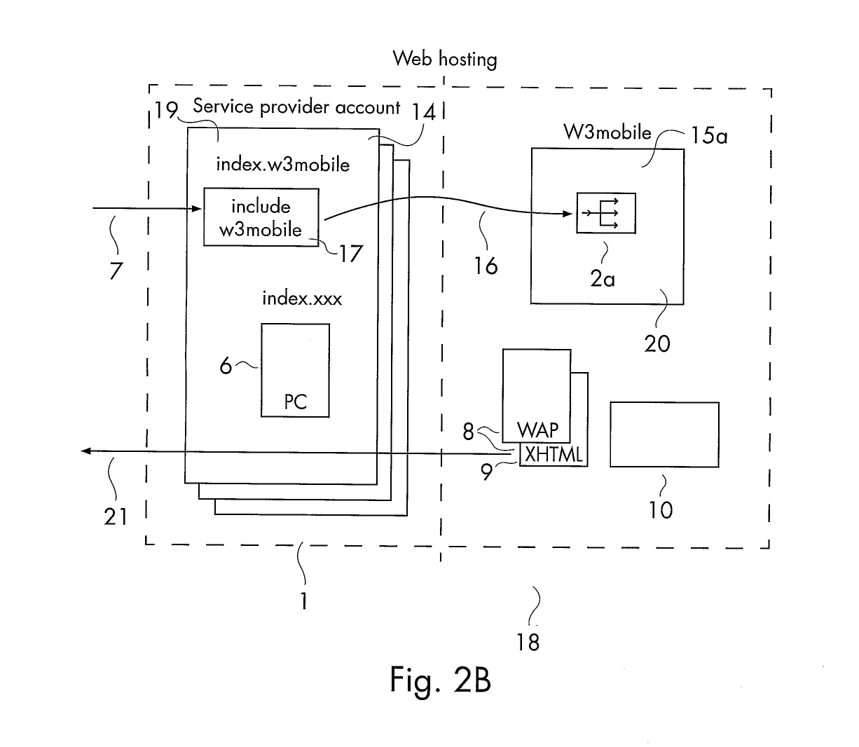

In FIG. 2a the data request 7 is forwarded by a first software means 17 in a first module 14, which forwards the data request 16 to a switching means 2 of a second module 15. In one embodiment the system relates to a reservation system for hotel or other similar type of accommodation. In such an embodiment at least one type of secure connection between the mobile terminal 3 and the system 1 is supported. A suitable connection may be based on handling certificates using SSL or similar. In the case of a hotel booking the booking number is typically used as means of identification. The second module 15 manages switching 2 to the terminal dependent version 9 of the web page. The embodiment of the system 1 in FIG. 2a indicates that the invention is particularly advantageous for use in a web hosting environment 18. Such as when a service provider has web pages in a web hosting environment 18 and wants to convey a terminal independent service. An example is a public tourist portal intending to provide mobile terminals with access to information such as opening hours for certain facilities. FIG. 2b shows a web hosting environment 18 comprising a number of accounts relating to service providers. The first module 19 is accessible in a service provider's account 14. The web hosting environment 18 comprises a separate account where the second module 15 resides. The second module 15 comprises the switching means 2. The first means 17 in the service provider's account 14 forwards 16 the incoming data request 7 to the switching means 2.

In one embodiment the system is at least partly configured by means of a programming environment based on Hypertext Preprocessor (php). Another language which is a suitable for configuring the system is C++. The indication of the name, index.w3mobile, comprised by the first software means 17 in FIG. 2a and FIG. 2b is an example. Many other names are possible.

The incoming data request 7 may be handled by a script in the web host environment 18 which passes the call to the first software means 17, such as index.w3mobile, which comprises an include statement of a file or other identifier of the switching means 2. An advantage with such a procedure is that each service provider's account does not need to comprise the full function of the switching means 2.

The switching means 2 performs a number of steps which typically involves detection of type of terminal 3 passing the data request 7 and presentation capabilities of the terminal 3. Examples of presentation capabilities are width of screen and language support.

The switching means 2 may be configured to evaluate if the data request from the mobile terminal 3 has at least one variable indicating that the mobile terminal supports xhtml in http_accept. The inventors have found that in contrast to what is specified in http_accept, some mobile terminals in practice do not support xhtml. A certain model of a mobile terminal may have problems with other capabilities that in an incorrect manner are specified as supported in the data request. An identifier of the type of such a mobile terminal 3 is comprised in a database. The switching means 2 forward the data request 7 to the terminal dependent version 9 that is compatible with the mobile terminal 3 based on information in the database, which describes which level or standard of a certain capability the model of mobile terminal supports. In the case of that xhtml is incorrect described in http_accept the switching means may forward the data request to the web page based on wml that is compatible with the mobile terminal 3.

The identification of the mobile terminal 3 is performed by means of the switching means 2. In one embodiment the identification is performed by a check of the content of the header parameters. The switching means may be configured to perform identification as of below:

if (stristr($_SERVER[“HTTP_ACCEPT”], “wap”)){$wap=‘yes’}=if true then the manufacturer of the mobile terminal states that it has support for wap
if (stristr($_SERVER[“HTTP_ACCEPT”], “application/xhtml+xml”)){$xhtml=‘yes’}=if true then the manufacturer of the terminal states that it has support for xhtml
if (stristr($_SERVER[“HTTP_ACCEPT”], “javascript”)){$javascript=‘yes’}=if true then the manufacturer of the terminal states that it has support for javascript
if (stristr($_SERVER[“HTTP_USER_AGENT”], “Symbian”)){$terminal=‘mobile’}=if true then the manufacturer of the terminal states that it is a mobile terminal
if (isset($_SERVER[“HTTP_X_WAP_PROFILE”])){$UAProf=$_SERVER[“HTTP_X_WAP_PROFILE”]}=the identification is performed to check for terminal capabilities such as screen width

In an embodiment shown in FIG. 2b the plurality of terminal dependent pages 8 are created by the auto generating means 10. In such an embodiment the terminal dependent version is created as the data request has been received and terminal capabilities have been established by the switching means 2. Such an embodiment is preferred when information is retrieved from a database that is frequently updated, such as a reservation system for accommodation. In the case of a reservation system it is an advantage if the data request comprises a booking or reservation reference for identification purposes.

A further advantage with the invention is that an inquiry made by the user, e.g. via telephone, can be responded by a person working for a content provider with one address only. The invention enables that it is enough to send one bookmark only. An example of such situation is when the user wants to find out about opening hours of a museum in a city the user has never visited before. In this case only one address needs to be sent e.g. via an SMS alternatively an E-mail. If the user utilizes the address for accessing from a mobile terminal, e.g. via GPRS, an automatically generated page comes up, showing opening hours only. If the user utilizes the address from a web browser in a PC a complete web page comes up presenting current themes and visiting exhibitions too.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A system (1) to address a web page independent of the type of terminal passing the address by means of a public mobile system (4), the system comprises a PC version of the web page (6) and a plurality of terminal dependent (8) versions of the web page characterized in that the system (1) comprises a first means (17) and a switching means (2), the first means (17) is configured to forward a data request (7) from a mobile terminal (3) to the switching means (2), which data request (7) comprises an address (5), which is exactly the same address used for traditional access of the PC version (6) of the web page, the switching means (2) is configured to transfer the data request (7) to the terminal dependent version (9) of the web page compatible with the mobile terminal (3).

2. A system (1) according to claim 1 characterized in that the switching means (2) comprises means to detect the type of mobile terminal performing the data request (7) and means to detect presentation capabilities of the mobile terminal (3), wherein the switching means (2) is configured to determine the terminal dependant version (9) of the web page to be used for presentation on the mobile terminal (3) based on the type of mobile terminal performing the data request (7) and on the presentation capabilities of the mobile terminal (3).

3. A system (1) according to claim 2 characterized in that the first means (17) resides in a web hosting environment (18) and the first means (17) comprises an include instruction of the switching means (2).

4. A system (1) according to claim 2 or 3 characterized in that the switching means (2) is configured to evaluate at least one environment variable of the data request (7), relating to capabilities of the mobile terminal (3) such as width of the screen of the mobile terminal (3) or relating to the type of mobile terminal (3).

5. A system (1) according to claim 4 characterized in that the switching means (2) is configured to access a database comprising a list of exceptions of mobile terminals non-compatible with the at least one variable, and the switching means (2) is adapted to determine which terminal dependent version (9) of the web page that is compatible with the mobile terminal (3) based on the information in the database.

6. A system (1) according to claim 5 characterized in that the system comprises a second means (10) to automatically generate the terminal dependant page (9).

7. A system (1) according to claim 6 characterized in that the second means (10) is configured to automatically generate the terminal dependent version (9) of the web page at the event of a data request (7).

8. A system (1) according to claim 7 characterized in that the second means (10) is configured to automatically generate the terminal dependant page (9) is capable of generating a page supporting xhtml.
